(19) United States
(12) Patent Application Publication
(10) Pub. No.: US 2022/0274519 A1
(43) Pub. Date: Sep. 1, 2022

(54) FOLDABLE ROOF FOR MOVABLE HABITATION

(71) Applicant: Jamie Mackay, Wilson, WY (US)

(72) Inventor: Jamie Mackay, Wilson, WY (US)

(21) Appl. No.: 17/682,224

(22) Filed: Feb. 28, 2022

Related U.S. Application Data
(60) Provisional application No. 63/155,205, filed on Mar. 1, 2021.

(51) Int. Cl. B60P 3/34; E04B 7/16; B60P 3/36

(52) U.S. Cl. CPC B60P 3/34; E04B 7/163; B60P 3/36; E04H 2001/1283

(57) ABSTRACT

A movable dwelling includes a roof that is foldable. The roof may be foldably attached to an exterior wall, or the roof may have a first panel foldably connected to a second panel. The foldable roof may have a retracted position that allows the movable dwelling to be more easily transported, and an extended position that allows the movable dwelling to have a vaulted ceiling when installed. The movable dwelling is built according to industry standards, such as the International Building Code, HUD codes, ANSI 119.2, NPFA 1192, and federal motor safety codes. A method of forming the movable dwelling is also disclosed.

### RELATED APPLICATIONS

This application claims priority to U.S. provisional application 63/155,205 (the '205 application) filed Mar. 1, 2021. The '205 application is hereby incorporated herein in its entirety.

### TECHNICAL FIELD

This disclosure relates generally to structures characterized by movable, or collapsible parts, and more specifically to structures with a hinged roof which is collapsible for transport. The features disclosed herein are numerous in nature and may be utilized in a number of different ways to provide the same or similar results for movable homes, recreational vehicles, and the like.

### BACKGROUND

Prefabricated foldable structures already exist and provide useful accommodation for permanent occupation and also for temporary housing. Foldable buildings are designed to meet the requirements of efficient transport, storage and erection, re-transport and reuse. Such designs fold out in a variety of different ways after arriving on site. Many however, rely on mechanical opening devices such as wheel and track systems while others require a crane to lift components into place. In most cases, the roof element needs to be temporarily supported while other elements are secured in place. Many of the structures have complicated folding systems which can be difficult to deploy. Additionally, they may prevent some luxury-style building elements from being used. For example, a fully foldable building cannot be pre-fabricated with an interior because it must be able to fully fold down. Similarly, foldable roof style dwellings do not allow for a vaulted ceiling that may be desirable in luxury-style transportable buildings.

More recently, pre-fabricated modular dwellings have become desirable, including an increase in demand for dwellings that include luxury features. The pre-fabricated buildings may include all the luxury interior elements of a high-end dwelling, such as tiled showers, vaulted ceilings, oversized windows, eight-foot doors, luxury appliances, etc. In some settings, these pre-fabricated modular dwellings may be provided as “turn-key,” that is, with all appliances and hardware installed.

Additionally, foldable structures do not have the technical code compliance for many types of codes, such as recreational vehicle codes and the like. Recreational vehicles must comply with several codes, such as ANSI 119.2, ANSI 119.5, fire protection codes like NFPA 1192, RVIA Standards, National Electrical Code standards like Article 551 and Article 552, Department of Transportation requirements such as the Federal Motor Vehicle Safety Standards as specified in Code of Federal Regulations, Title 49 Part 571, etc. Other compliance codes that may be desirable for a movable building with foldable components includes the International Building Code, HUD code, and other state and local building codes. Additionally, compliance with the standards set forth with the U.S. Green Building Council may be desirable.

The building with a foldable/hingeable roof disclosed herein takes into account the various codes for compliance for recreational vehicles, and codes for compliance with building codes such as the HUD code and International Building Code. Additionally, it may allow for a pre-fabricated moveable structure that incorporates luxury features not available with other foldable dwellings, such as a fully finished interior including appliances, and a vaulted ceiling.

### SUMMARY

In one aspect, this disclosure relates to a new design for a movable dwelling. A movable building with an expandable roof may include: a roof portion, the roof portion comprising a first panel foldably connected to a second panel; one or more exterior walls supporting the roof portion; a chassis for supporting the movable building, the chassis being permanently affixed to the movable building; and wherein the movable building complies with ANSI 119.2 and NPFA 1192.

In some configurations, the roof portion comprises a first roof portion and a second roof portion opposite the first roof portion, the roof portion having an expanded position and a retracted position. The first roof portion and the second roof portion are substantially horizontal in the retracted position.

In some configurations, the first roof portion and the second roof portion form a gabled roof in the expanded position. The building may have a vaulted ceiling when the roof portion is in the expanded position.

According to another aspect, an expandable roof assembly for a building includes: the roof assembly having a retracted condition and an extended condition, the roof assembly being movable between the retracted and extended condition, the roof assembly comprising: a roof portion; and one or more exterior walls, the roof portion foldably attached to the one or more exterior walls.

The roof portion may comprise a first section and a second section, with a hinge connecting the first section to the second section, and wherein a cut-away on an interior side of the first section provides a space for the second section to extend downwardly in the retracted position with the first section remains stationary.

According to another aspect, the system or assembly may include at least one wall plug installable to hold the roof in the extended condition. According to one method, the assembly may be provided with the wall plug pre-fabricated and located within the building during shipment. Once the building arrives at its final location, the roof assembly may be raised and the pre-fabricated wall plug may be inserted.

According to another aspect, a movable building having a roof with an extended and a retracted position, the building comprises: a roof portion and one or more exterior walls, the roof portion foldably attached to the one or more exterior walls; at least one stove coupled to an interior of the movable dwelling, the stove coupled to a propane line, and a compartment for storage of a propane tank, the compartment being vaportight to the interior of the movable dwelling; at least one plumbing fixture coupled to the interior of the movable dwelling, the at least one plumbing fixture having backflow contamination prevention, a trap, and a vent; at least one electrical receptacle coupled to the interior of the movable dwelling, the at least one electrical receptacle electrical receptacle comprising a ground fault protected electrical receptacle; and a subfloor permanently affixed to the movable dwelling, the subfloor comprising a chassis with a plurality of steel I-beams welded to the chassis.

In some configurations, the subfloor further comprises a rectangular structure formed from I-beams, and a plurality of transverse I-beams bracing the rectangular structure. The subfloor forms a rigid flat-bottomed base for supporting the movable dwelling. The subfloor may include a living area support portion and a kitchen-bath support portion. The chassis further comprises a ball hitch to form a towable trailer.

According to another aspect, the movable building includes a propane tank coupled to the propane line, the propane tank comprising an overfill protection device. In some configurations, the movable dwelling is not removable from the chassis.

According to another aspect, the movable building includes at least one wall plug installable to hold the roof in an extended condition (either pre-fabricated or constructed on-site).

According to yet another aspect, the roof portion comprises a first panel foldably connected to a second panel. The first panel may be formed of a first section and a second section, a hinge connecting the first section to the second section, and wherein a cut-away on an interior side of the first section provides a space for the second section to extend downwardly in a retracted position with the first section remains stationary.

According to another aspect, the movable building complies with the following codes: ANSI 119.2, ANSI 119.5, NFPA 1192, RVIA Standards, and CFR Title 49 Part 571.

The movable building may have a roof with a first panel is formed of a first section and a second section, and wherein a hinge connects the first section to the second section, and wherein a cut-away on an interior side of at least one of the first section and section provides a space for the second section too extend downwardly in the retracted position with the first section remains stationary

There is a plurality of means and methods for forming the movable dwelling and multiple variations are disclosed herein. Other aspects, as well as features and advantages of various aspects of the disclosed subject matter will become apparent to one of ordinary skill in the art from the ensuing description, the accompanying drawings and the appended claims.

### BRIEF DESCRIPTION OF DRAWINGS

The detailed description is described with reference to the accompanying figures. The components in the drawings are not necessarily to scale relative to each other. Like reference numerals designate corresponding parts throughout the several views.

FIG. 1 is a plan view of an exemplary movable dwelling with a foldable roof as disclosed herein.

FIG. 2 is another plan view of a movable dwelling with a foldable roof as disclosed herein.

FIG. 3 is a close-up plan view of a foldable roof panel according to one aspect disclosed herein.

FIG. 4 is a plan view of another exemplary movable dwelling with a foldable roof as disclosed herein.

It will be appreciated that the drawings are illustrative and not limiting of the scope of the disclosure which is defined by the appended claims. The various elements of the disclosure accomplish various aspects and objects of the disclosure. It is appreciated that not every element of the disclosure can be clearly displayed in a single drawing, and as such not every drawing shows each element of the disclosure.

### DETAILED DESCRIPTION

Various aspects of the disclosure and accompanying drawings will now be discussed in reference to the numerals provided therein to enable one skilled in the art to practice the present invention. The drawings and the descriptions are exemplary of various aspects of the invention and do not narrow the scope of the appended claims. Furthermore, it will be appreciated that the drawings may show aspects of the invention in isolation and the elements in one figure may be used in conjunction with elements shown in other figures.

Reference in the specification to “one embodiment,” “one configuration,” “an embodiment,” or “a configuration” means that a particular feature, structure, or characteristic described in connection with the embodiment may be included in at least one embodiment, etc. The appearances of the phrase “in one embodiment” in various places may not necessarily limit the inclusion of a particular element of the invention to a single embodiment, rather the element may be included in other or all embodiments discussed herein. Likewise, it is not required that any feature in one embodiment be included in the invention as described by the claims unless that feature is expressly mentioned in the claims.

Furthermore, the described features, structures, or characteristics of embodiments of the present disclosure may be combined in any suitable manner in one or more embodiments. In the following description, numerous specific details may be provided, such as examples of products or manufacturing techniques that may be used, to provide a thorough understanding of embodiments of the invention. One skilled in the relevant art will recognize, however, that embodiments discussed in the disclosure may be practiced without one or more of the specific details, or with other methods, components, materials, and so forth. In other instances, well-known structures, materials, or operations may not be shown or described in detail to avoid obscuring aspects of the invention.

Before the present invention is disclosed and described in detail, it should be understood that the present invention is not limited to any particular structures, process steps, or materials discussed or disclosed herein, but is extended to include equivalents thereof as would be recognized by those of ordinarily skill in the relevant art. More specifically, the invention is defined by the terms set forth in the claims. It should also be understood that terminology contained herein is used for the purpose of describing particular aspects of the invention only and is not intended to limit the invention to the aspects or embodiments shown unless expressly indicated as such. Likewise, the discussion of any particular aspect of the invention is not to be understood as a requirement that such aspect is required to be present apart from an express inclusion of that aspect in the claims.

As used in this specification and the appended claims, singular forms such as “a,” “an,” and “the” may include the plural unless the context clearly dictates otherwise. Thus, for example, reference to “an exterior wall” may include an embodiment having one or more of such exterior walls, and reference to “the door” may include reference to one or more of such doors.

As used herein, the term “substantially” refers to the complete or nearly complete extent or degree of an action, characteristic, property, state, structure, item, or result to function as indicated. For example, a portion that is “substantially” horizontal is either completely horizontal or nearly completely horizontal. The exact allowable degree of deviation from absolute completeness may in some cases depend on the specific context, such that an element that is 1 to 15 degrees above horizontal is substantially horizontal, even if it is slightly above exact horizontal at zero degrees. The use of “substantially” is equally applicable when used in a negative connotation to refer to the complete or near complete lack of an action, characteristic, property, state, structure, item, or result.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience. However, these lists should be construed as though each member of the list is individually identified as a separate and unique member.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

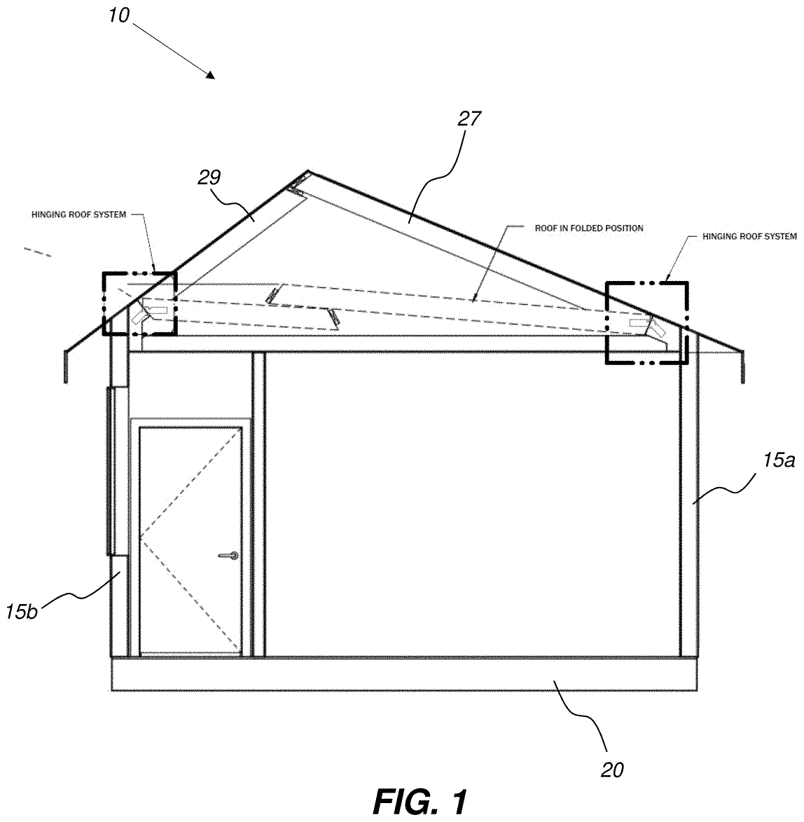

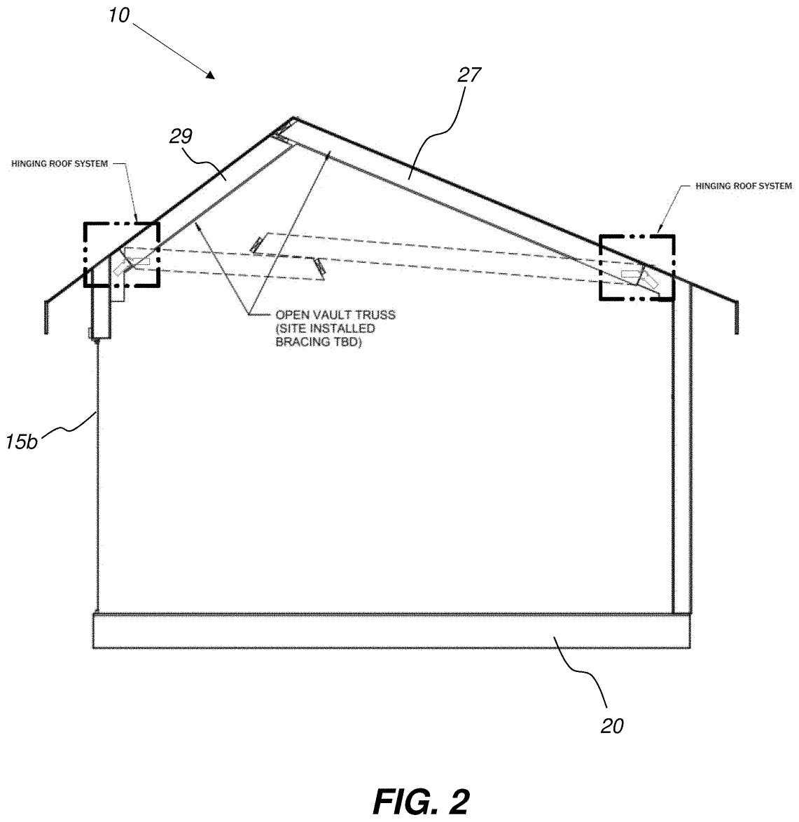

Turning now to FIGS. 1-2, there is shown several plan views of a movable dwelling with a foldable roof, generally indicated at 10. The movable dwelling may generally be comprised of one or more exterior walls 15, a chassis or subfloor 20, and a roof portion 25. The dwelling 10 may be any suitable shape and size desired. For example, the dwelling may be of a size that it may be movable and transportable on a U.S. highway, and thus may be equal to or less than 2.6 meters (8.5 feet) wide. Or the dwelling may be of a size that it may be movable on a U.S. highway as an “oversized load” and thus may be less than 3.65 meters (12 feet) wide. In some configurations, the dwelling may be about 3.2 meters (10.5 feet) wide. The movable dwelling may be formed of any suitable materials, such as wood, concrete, or any other suitable building materials.

The roof portion 25 of the dwelling 10 may be any suitable roof desired. In some configurations, the roof may be a roof that allows the dwelling to have a vaulted ceiling. In structures such as tiny homes, it may be desirable to allow vaulted ceilings to increase the size and sense of the size of the home. For example, a gabled roof may be used. Any type of gable roof desired may be used, such as open gable, boxed gable, side gable, crossed gable, front gable, or Dutch gable. In other configurations, other types of roofs, such as a shed roof or skillion roof may be used. In one specific configuration, an open gable roof may be used to simplify construction of the dwelling, simplify construction of the roof, and ease transportation of the dwelling. In another specific configuration, a skillion roof may be used to simplify construction of the dwelling, simplify construction of the roof, and ease transportation of the dwelling. In other configurations, other styles of roof may be used, and the roof need not be a gable or skillion roof.

In the specific configuration show in FIGS. 1-2, the roof portion 25 may be formed of a first roof panel 27 and a second roof panel 29. The first roof panel 27 may be foldably attached to a first exterior wall 15a. The second roof panel 29 may be foldably attached to a second exterior wall 15b, the second exterior wall 15b opposing the first exterior wall 15a. In other configurations, the roof panels may be permanently or non-foldably attached to the exterior walls, and rather may be provided with a hinge or foldable portion in the roof panel. The foldable attachment may be achieved by any suitable means. For example, a hinge may be provided on each of the first roof panel 27 and second roof panel 29. The hinge would allow each roof panel to have an extended position and a retracted position (retracted position shown in dashed lines in FIGS. 1-2). In the retracted position, each of the first roof panel 27 and second roof panel 29 would be substantially horizontal.

In some configurations, the first roof panel 27 may be slightly larger than the second roof panel 29, such that in the extended position, the first roof panel 27 overlaps the second roof panel 29. In the extended position, the first roof panel 27 and the second roof panel 29 combine to form a single roof of the building. One or more seals between the first roof panel 27 and second roof panel 29 may be provided to prevent the ingress of water between the roof panels and through the roof in the extended position. In one embodiment, the roof comprises a first roof panel 27 and a second roof panel 29, with the first roof panel 27 overlapping the second roof panel 29 in one or both of the retracted position and the extended position.

In other configurations, the roof may be provided with a single roof panel, such as a skillion roof with a single panel. In these configurations, the roof panel may have a hinge, pivot, or other type of joint at a point along the roof panel. This may allow the roof panel to extend or retract as it is moved about the hinge or pivot point. In some configurations, the foldable roof may have no other additional supports or structures to enable the foldability of the roof. That is, only a hinge or pivot may be provided along one or more roof panels. This may make construction of the foldable roof easier, as well as make it simpler to change the roof between the extended and retracted positions. As needed, additional support structures for the roof may be added at the installation site.

A configuration of the foldable roof as shown in FIGS. 1-2 may allow for the movable dwelling 10 to have a vaulted ceiling when the foldable roof is in an extended position. It may also allow the foldable roof to have a retraced position that still allows for the movable dwelling 10 to have an interior that is fully built, including rooms, appliances, etc. This may particularly make construction and installation of luxury-style turnkey movable dwellings simpler, as well as ease the burden of transporting the dwellings without sacrificing the style and quality of construction.

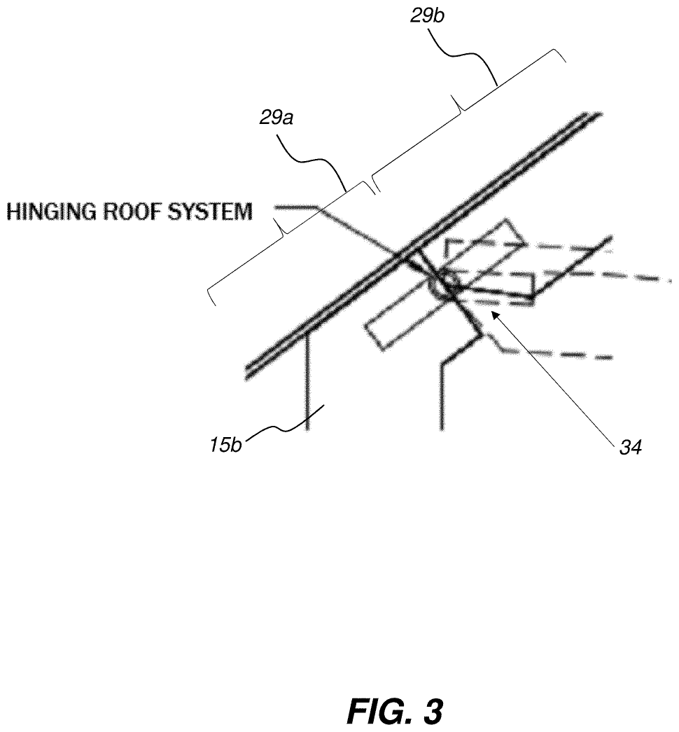

Turning now to FIG. 3, there is shown a close-up view of one configuration of a hinge that may be used for one or more roof panels as described herein. The roof panel may be provided with a foldable connection directly to an exterior wall, or the roof panel may be provided with a hinge or pivot at another location along the roof panel. For example, in FIG. 3, the roof panel is provided with a hinge 30, and a first section 29a and a second section 29b of the roof panel 29 are connected via the hinge 30. Additionally, there may be a notch or cut-out or cut-away 34 on an interior side of the roof panel. For example, one or more of the first section 29a and/or second section 29b may be provided with a notch 34. This notch 34 allows space for the second section 29b of the roof panel 29 to extend downwardly in the retracted position, while the first section 29a of the roof panel 29 remains stationary.

The exterior walls 15 and roof portion 27, 29 may form an interior of the movable dwelling. The interior may be provided with various features common in dwellings, such as a living area, and/or a kitchen-bath area. The interior and other structures of the movable dwelling may be built to meet or exceed all relevant codes. For example, Recreational Vehicle Industry Association and the American National Standards Institute 119.2 and 119.5, National Fire Protection Association 1192, etc., are codes which govern recreational vehicles, all of which are incorporated herein by reference in their entireties. The movable dwelling 10 may also comply with RVIA Standards, National Electrical Code standards like Article 551 and Article 552, Department of Transportation requirements such as the Federal Motor Vehicle Safety Standards as specified in Code of Federal Regulations, Title 49 Part 571, the International Building Code, HUD codes, etc. The movable dwelling 10 may also be built to meet or exceed all International Building Codes, and HUD building codes, all of which are incorporated herein by reference in their entireties.

By way of example, the living area may include a sitting area such as a couch and/or table. The kitchen-bath area may include a stove coupled to the dwelling, and one or more plumbing fixtures such as a toilet and/or sinks. Both the living area and the kitchen-bath area may include electrical receptacles. Depending on the location of the electrical receptacles, the electrical receptacles may comprise ground fault protected electrical receptacles in accordance with code.

Similarly, in order to be built to code, a propane or gas line may be provided to the stove, and a compartment may be formed in the movable dwelling for storage of a propane tank. The compartment for storing a propane tank may be vaportight to the interior of the movable dwelling to comply with RVIA-ANSI code. Preferably, the propane line is formed from one of steel, wrought iron, copper, or brass as required by code. In some configurations, a propane tank may be coupled to the propane line, and the propane tank may comprise an overfill protection device. Each of the plumbing fixtures coupled to the movable dwelling may be provided with a backflow contamination prevention, a trap, and a vent. According to another aspect, the movable dwelling may also be provided with an extension portion or slide-out.

As noted above, the movable dwelling may be permanently affixed to a chassis. The chassis may form a subfloor 20, or may act as a subfloor. This may have the advantage or allowing the movable dwelling to be driven onto a foundation and act as a home without a need for any additional subfloor. In other configurations, the movable dwelling may not be provided with a chassis.

The subfloor 20 may comprise a plurality of steel I-beams. The chassis may be formed in any suitable configurations, such with a first main rail and a second main rail. The main rails may comprise steel I-beams, and are welded at each end to a header rail, such as a first header rail and a second header rail. The main rails and header rails thus form a rectangular support structure. The header rails may similarly comprise steel I-beams welded to the main rails. A plurality of transverse I-beams, welded between the main rails, may also be provided to further brace and support the structure. The subfloor may comprise a living area support portion and a kitchen-bath support portion. The living area support portion may generally be below the living area and the kitchen-bath support portion may be generally below the kitchen-bath area. In some configurations, the kitchen-bath support portion may include additional transverse support beams compared to the living area support portion.

The movable dwelling described herein may be provided with a ball hitch 95 such that it may form a towable trailer. In other configurations, the chassis 20 may be permanently affixed to a motorized vehicle to form a standalone movable dwelling.

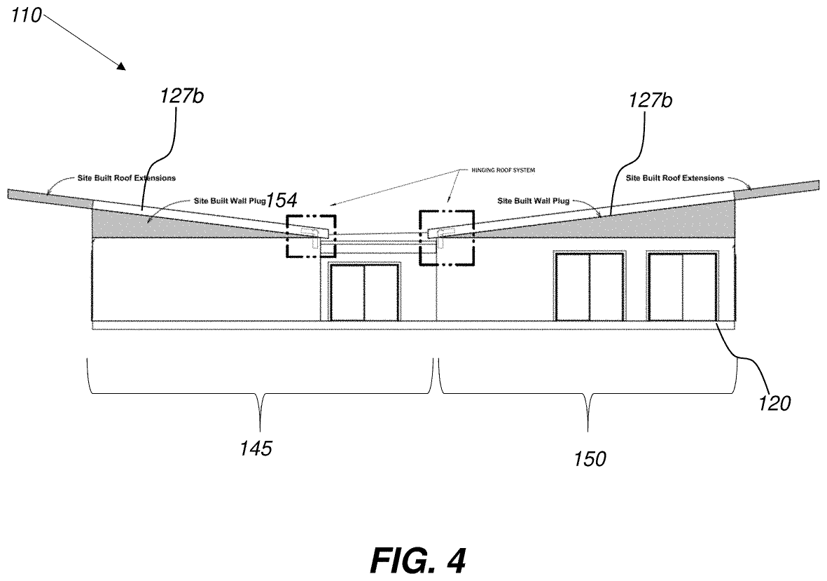

FIG. 4 shows another configuration for a movable dwelling 110 having a foldable roof. In this configuration, one or more modular units 145, 150 are provided. The modular units may be constructed off-site for cost and quality purposes, and then each modular unit may be moved to the installation site and connected. Each separate modular unit 145, 150 may be provided with a foldable roof 127a, 127b. In the particular configuration shown in FIG. 4, skillion-type roofs are shown, but it will be appreciated that other types of roofs may be used and such are contemplated herein. After off-site construction is complete, which may optionally include providing a turn-key movable dwelling with appliances and plumbing fixtures, the foldable roof may be placed in the retracted position (shown in dashed lines in FIG. 4). The movable dwelling 110 may then be moved to the installation site. After the dwelling has been placed at the appropriate location, the roof may be moved to the extended position, allowing for a vaulted ceiling in the movable dwelling 110. One or more inserts or wall plugs 154 may be either constructed on-site and placed, or constructed and brought to the site for installation. Similarly, one or more roof extensions may be constructed and/or installed at the installation site.

According to one method, the assembly may be provided with the wall plug pre-fabricated and located within the building during shipment. Once the building arrives at its final location and is in place, the roof assembly may be raised and the pre-fabricated wall plug may be inserted. In other methods, the wall plug 154 may be constructed on-site.

The present disclosure also relates to a method of constructing and installing a movable dwelling with a foldable roof. For example, the first step may be to construct the movable dwelling. The movable dwelling may be constructed from any suitable materials, and may be provided as a turn-key dwelling with appliances and rooms installed.

The method may also include coupling at least one stove to the interior of the movable dwelling, coupling at least one plumbing fixture to the interior of the movable dwelling, the at least one plumbing fixture having backflow contamination prevention, a trap, and a vent; and coupling at least one ground fault protected electrical receptacle to the interior of the movable dwelling. The method may also include the step of permanently affixing the movable dwelling to a chassis. The movable dwelling may be permanently affixed to the chassis such that no portion may be removed from the chassis, but will remain affixed to the chassis at all times (whether during transportation down a road or parked in use for shelter).

While the present disclosure shows various specific embodiments of the movable dwelling with a foldable roof, it will be appreciated in light of the present disclosure that other configurations may be used in accordance with principle of the present invention. Thus it should be appreciated that the appended claims are not limited by the specific embodiments discussed herein.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

Thus there is disclosed an improved movable dwelling with a foldable roof. Those of skill in the art will appreciate that numerous modifications may be made hereto without departing from the scope and spirit of the invention. The appended claims are intended to cover such modifications.

What is claimed is:

1. A movable building with an expandable roof comprising:
a roof portion, the roof portion comprising a first panel foldably connected to a second panel;
one or more exterior walls supporting the roof portion;
a chassis for supporting the movable building, the chassis being permanently affixed to the movable building; and
wherein the movable building complies with ANSI 119.2 and NPFA 1192.

2. The movable building of claim 1, wherein the roof portion comprises a first roof panel and a second roof panel opposite the first roof panel, the roof portion having an expanded position and a retracted position.

3. The movable building of claim 2, wherein the first roof portion and the second roof portion are substantially horizontal in the retracted position.

4. The movable building of claim 2, wherein the first roof portion and the second roof portion form a gabled roof in the expanded position.

5. The movable building of claim 2 having a vaulted ceiling when the roof portion is in the expanded position.

6. An expandable roof assembly for a building comprising:
the roof assembly having a retracted condition and an extended condition, the roof assembly being movable between the retracted and extended condition, the roof assembly comprising:
a roof portion; and
one or more exterior walls, the roof portion foldably attached to the one or more exterior walls.

7. The expandable roof assembly of claim 6,
wherein the roof portion comprises a first roof panel comprised of a first section and a second section, with a hinge connecting the first section to the second section, and wherein a cut-away on an interior side of the first section provides a space for the second section to extend downwardly in the retracted position with the first section remains stationary.

8. The expandable roof assembly of claim 6, further comprising at least one wall plug installable to hold the roof in the extended condition.

9. A movable building having a roof with an extended and a retracted position, the building comprising:
a roof portion and one or more exterior walls, the roof portion foldably attached to the one or more exterior walls;
at least one stove coupled to an interior of the movable dwelling, the stove coupled to a propane line, and a compartment for storage of a propane tank, the compartment being vaportight to the interior of the movable dwelling;
at least one plumbing fixture coupled to the interior of the movable dwelling, the at least one plumbing fixture having backflow contamination prevention, a trap, and a vent;
at least one electrical receptacle coupled to the interior of the movable dwelling, the at least one electrical receptacle electrical receptacle comprising a ground fault protected electrical receptacle; and
a subfloor permanently affixed to the movable dwelling, the subfloor comprising a chassis with a plurality of steel I-beams welded to the chassis.

10. The movable building of claim 9, wherein the subfloor further comprises a rectangular structure formed from I-beams, and a plurality of transverse I-beams bracing the rectangular structure.

11. The movable building of claim 10, wherein the subfloor forms a rigid flat-bottomed base for supporting the movable dwelling.

12. The movable building of claim 10, wherein the subfloor comprises a living area support portion and a kitchen-bath support portion.

13. The movable building of claim 9, wherein the chassis further comprises a ball hitch to form a towable trailer.

14. The movable building of claim 9, further comprising a propane tank coupled to the propane line, the propane tank comprising an overfill protection device.

15. The movable building of claim 9, wherein the movable dwelling is not removable from the chassis.

16. The movable building of claim 9, further comprising at least one wall plug installable to hold the roof in an extended condition.

17. The movable building of claim 9, wherein the roof portion comprises a first panel foldably connected to a second panel.

18. The movable building of claim 17, wherein the first panel is formed of a first section and a second section, a hinge connecting the first section to the second section, and wherein a cut-away on an interior side of the first section provides a space for the second section to extend downwardly in a retracted position with the first section remains stationary.

19. The movable building with an expandable roof of claim 1, wherein the movable building complies with the following codes: ANSI 119.2, ANSI 119.5, NFPA 1192, RVIA Standards, and CFR Title 49 Part 571.

20. The movable building with an expandable roof of claim 2, wherein the first panel is formed of a first section and a second section, and wherein a hinge connects the first section to the second section, and wherein a cut-away on an interior side of at least one of the first section and section provides a space for the second section too extend downwardly in the retracted position with the first section remains stationary.
